(19) United States
(12) Patent Application Publication
(10) Pub. No.: US 2009/0313506 A1
(43) Pub. Date: Dec. 17, 2009

(54) Test Result Aggregation and Analysis Using Text Expressions

(75) Inventors: Michael Elizarov, Sammamish, WA (US); Eldar A. Musayev, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/138,403

(22) Filed: Jun. 12, 2008

(51) Int. Cl. G06F 11/00

(52) U.S. Cl. 714/37; 714/E11.02

(57) ABSTRACT

A test and analysis system may use Xpath or other text based analysis descriptors to analyze test results that may be presented in XML. The text based analysis descriptors may be installed and used on an analysis system without exposing the analysis system to security vulnerabilities, and such descriptors may be frequently updated and distributed. A server device may have a test manager that may coordinate tests performed on other devices connected through a local area network, and may gather and store the test results for analysis. In some cases, the test results may be converted to XML for analysis.

### BACKGROUND

Diagnosing problems on a computer device or a network of computer devices may involve analyzing various symptoms and identifying potential problems based on the symptoms. In many cases, the symptoms may be detected by performing various diagnostic tests on the various devices, and the tests may be performed by different executable applications or services. In the case of a networked group of devices, the different tests may be performed on different devices across the network.

Diagnostic applications may use complex algorithms to make a diagnosis, and often such algorithms may be expressed in executable code. When executable code is installed and operated on a device, the executable code may pose a security risk, as such code may contain viruses, Trojan horses, worms, or other malicious code. Hence, when such executable code is distributed, the distributor generally verifies the executable code and digitally signs the code. Such complexities may increase the complexity and response time when an update is created and distributed.

### SUMMARY

A test and analysis system may use Xpath or other text based analysis descriptors to analyze test results that may be presented in XML. The text based analysis descriptors may be installed and used on an analysis system without exposing the analysis system to security vulnerabilities, and such descriptors may be frequently updated and distributed. A server device may have a test manager that may coordinate tests performed on other devices connected through a local area network, and may gather and store the test results for analysis. In some cases, the test results may be converted to XML for analysis.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a test or diagnostic system.

FIG. 2 is a flowchart illustration of an embodiment showing a method for managing tests.

FIG. 3 is a flowchart illustration of an embodiment showing a method for analyzing test results.

### DETAILED DESCRIPTION

A test analysis system may use diagnostic descriptions that are presented in a text based format, such as Xpath. The diagnostic descriptions may include various analyses of data so that diagnostic conclusions may be reached. Such a system may be useful in a setting where the diagnostic descriptions may be periodically updated through a distribution mechanism.

Text based descriptions may be safely distributed because text files are not executable files and may not contain viruses, worms, or other malicious software. Thus, an updated text based description may be easily created, distributed, and installed without having to perform checks for embedded malicious software.

Xpath is one type of text based expression that may be used for analyzing test results, especially when the test results are presented in XML format. Xpath diagnostic descriptions may be defined for complex analyses over groups of test results that may be gathered from multiple sources.

A typical embodiment may include a test server that may manage tests that may be performed on several managed devices. One such application may be a test server that may manage tests and diagnosis for a local area network and the various devices attached to the network. Test results may be gathered from each device and analyses performed using all of the test results to diagnose conditions or problems within the network. Such embodiments may diagnose both device specific and overall network related conditions.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

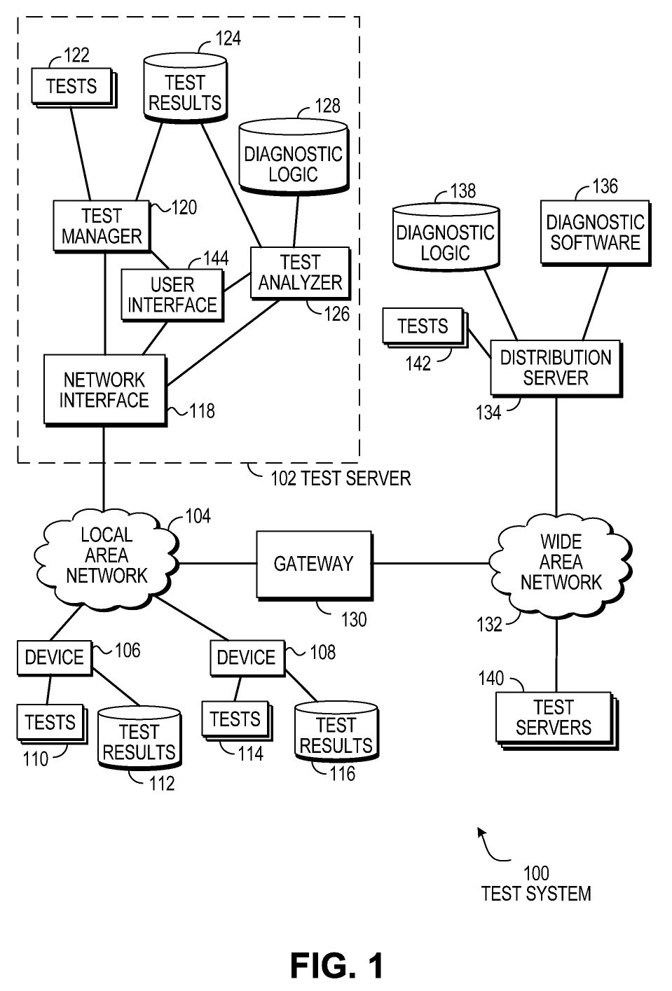

FIG. 1 is a diagram of an embodiment 100 showing a system for managing and analyzing tests within a local area network. Embodiment 100 is a simplified example of a system that may use text based descriptors of diagnostic logic the prophylactic or on demand distribution of diagnostic logic.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 100 is an example of a test server 102 that may manage tests and perform diagnoses within a local area network 104 that may have several devices 106 and 108. The test server 102 may gather test results from the devices and may analyze the test results using a text based diagnostic logic.

A typical embodiment may be a local area network of an enterprise, company, or household, where a server device performs the functions of the test server 102. The test server 102 may perform analyses and diagnoses of various problems relating to a single device and to situations where multiple devices may interact. In one example, the test results from many different devices on a local area network may be analyzed to determine if a problem exists with server configurations or network configurations. By gathering data from many different sources and analyzing the data together, diagnoses may be made on a network-wide basis.

The devices 106 and 108 may be any type of device connected to the local area network 104. In a typical embodiment, the devices 106 and 108 may be a personal computer, server computer, network appliance, network enabled printer, or some other network device. The devices 106 and 108 may also be a portable device connected to the local area network 104 using a wireless connection, such as a personal digital assistant, mobile telephone, handheld scanning device, or other wireless device. In some cases, the devices 106 and 108 may include network access devices, routers, hubs, network access ports, base stations, or other network infrastructure devices.

Device 106 may have a set of tests 110 and a set of test results 112. Similarly, device 108 may have a set of tests 114 and a set of test results 116. In many embodiments, a network connected device may have self diagnostic tests that may be periodically executed. The tests may be distributed with the device in some cases. In other cases, a test manager 120 within the test server 102 may install and manage one or more tests 122 that operate on the devices 106 and 108.

When a device has a set of built in or preexisting tests, the test server 102 may be able to use the results from such tests in various diagnoses. For example, many devices may contain an operating system that includes some diagnostic features or may have applications that periodically execute and may generate useful results.

An example of such an application may be an anti-virus scanning application. Such an application may run periodically and may generate results that may be useful for various diagnoses. Other examples of such applications may include applications that log communications or performance characteristics for the various aspects of the device, application, or network communication.

In some cases, a device 106 or 108 may have several specific tests that may be installed and managed by the test server 102. In such a case, the test server 102 may cause specific tests to be installed that the test server 102 may cause the tests to be executed periodically or on demand. The test server 102 may gather the test results 112 and 116 from the devices 106 and 108 periodically or when an analysis is to be executed.

Some embodiments may have tests that execute on a test server 102 and generate test results for conditions on or performance of the devices 106 and 108. In one example, a test executing on the test server 102 may query various status and performance data from the device 106 or 108. In another example, a test operable on the test server 102 may actively or passively exercise or monitor a network connection or other function on the device 106 or 108 to determine the function's performance or status.

In some cases, a locally executed test 110 or 114 may generate results that are stored locally in test results 112 and 116, respectively. The devices 106 and 108 may be configured to periodically send the test results 112 and 116 to the test server 102. In some cases, the test server 102 may request the test results 112 and 116, and in other cases, the test server 102 may have direct access to the test results 112 and 116.

The test server 102 may have a network interface 118 that may connect the test server 102 to the local area network 104. The test manager 120 and test analyzer 126 may access the local area network 104 through the network interface 118.

The test manager 120 may store various tests 122 that may be installed and executed on the devices 106 and 108. The tests 122 may be downloaded or otherwise received from a distribution server 134.

The distribution server 134 may be accessed by the test server 102 through the local area network 104, a gateway 130, and a wide area network 132. In some cases, portions of the wide area network 132 may include the Internet.

The distribution server 134 may provide tests 142 to the test server 102 for installation and execution on the test server 102 or on the devices 106 and 108. Some embodiments may have a subscription mechanism by which updated tests 142 may be downloaded using a push or pull mechanism to the test server 102 and stored as tests 122. The tests 122 may be then installed on the devices 106 and 108.

The test manager 120 may manage the various tests. The management may include installation and operation of the tests. In some cases, tests may be operated on a periodic basis and may be configured to automatically execute on a schedule or in response to other events. In some cases, the test may be configured to execute in response to a request for test results which may occur when an analysis or diagnosis may be performed.

The test manager 120 may gather some or all of the test results 112 and 116 and store the test results in a test result database 124. In some cases, one test may be configured to store results locally and another test may be configured to transmit results to the test results database 124. At the time the test results may be used, the test manager 120 may collect or gather test results from various locations so that the test analyzer 126 may perform an analysis or diagnosis.

The test analyzer 126 may analyze the various test results to determine various conditions about individual devices, applications or services operating on the devices, network configuration, network performance, applications or services operating over the network, or any other condition or conclusion that may be derived or determined from the various test data.

The various tests and analyses of the test results may vary dramatically from one embodiment to another. In a small network that may be in a person's home, the test analyzer 126 may determine various conditions about the network and the attached devices. In some cases, the test analyzer 126 may be able to evaluate if various applications, functions, or services are properly configured and operating across the network.

In other embodiments, the test analyzer 126 may be applied to evaluate the network performance of a large wireless network that contains many handheld mobile communication devices. In another embodiment, the test analyzer 126 may be used to evaluate the configuration of a local area network 104 that contains many different sensors or monitoring instruments.

The test analyzer 126 may use a diagnostic logic 128 that may be defined using a text based definition mechanism. One such mechanism may incorporate Xpath descriptions of data. Xpath is a language that may be used, among other things, to analyze XML files to identify elements within the XML files.

The diagnostic logic 128 may be received from the distribution server 134. The distribution server 134 may download updated diagnostic logic 138 to the test server 102 and other test servers 140 on a periodic basis. In some such embodiments, the diagnostic server 134 may push the updated diagnostic logic 138 while in other embodiments, the test servers 102 may pull the diagnostic logic 138.

A push type distribution system may involve the distribution server 134 initiating the transmittal of information to a recipient device. A pull type distribution system may involve the recipient device initiating the transmittal of information from the distribution server 134.

The distribution server 134 may also distribute diagnostic software 136. The diagnostic software 136 may include installation software for the test manager 120, test analyzer 126, and other functional elements of the test server 102.

The test server 102 may have a user interface 144 that may be used by an administrator to operate and manage the test server 102 as well as view results from the test analyzer 126. In some embodiments, the user interface 144 may be a console interface to a hardware platform on which the test server 102 may operate. In other embodiments, the user interface 144 may be a web interface that may be accessed from a device connected to the local area network 104 using a browser interface.

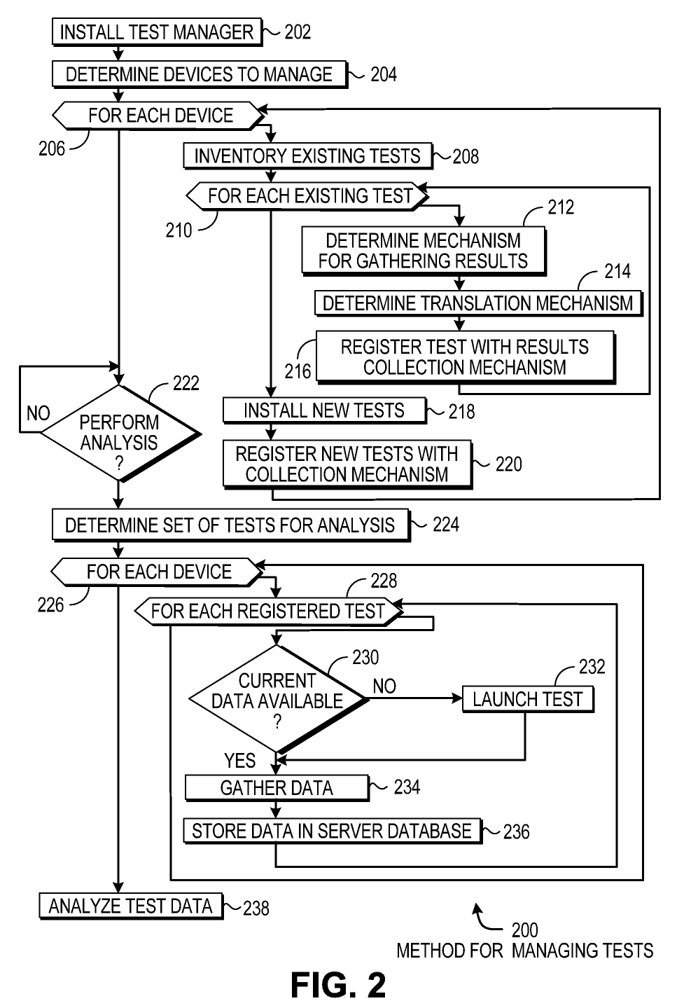

FIG. 2 is a flowchart illustration of an embodiment 200 showing a method for managing tests. Embodiment 200 illustrates a simplified sequence for managing existing and new tests on a device. The tests may be installed, configured, and executed by the management system.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 is an example of some of the functions that may be performed by the test manager 120 of embodiment 100. The functions include installation, discovery, and tracking of new or existing tests.

A test manager may be installed in block 202. The installation of block 202 may be performed when a device is configured as a test server. The test server may be configured to manage tests that may be performed on the test server as well as several other devices. The test manager may be installed as part of a larger installation package that may comprise a monitoring and diagnosis system, which may include other functions including a test analyzer.

The devices to manage may be determined in block 204. The embodiment 200 is an example of an embodiment that may be used to manage tests and test results over several different devices. Such embodiments may be useful for managing a network environment where individual devices as well as applications or services available over the network may be analyzed and diagnosed.

In block 204, the determination of the devices to be managed may be performed in several different manners. For example, a user or administrator may operate a user interface through which the user may enter or select the appropriate devices to manage. In another example, the test manager may have an automated discovery mechanism to determine devices to manage. In some cases, the test manager may use a list of devices that are being managed by another service or function, such as an administrative management service.

For each device in block 206, the device may be configured to operate with the test manager. In some cases, each device may be prepared or configured using identical processes. In other cases, different device types may be configured using variations on a process or using completely different processes.

The configuration process may begin with an inventory of existing tests in block 208. In many devices, an operating system or application may include various diagnostic functions that may generate useful results. Such functions or applications may be detected in block 208.

For each existing test in block 210, a mechanism for gathering results may be determined in block 212. The mechanism for gathering results may provide some kind of interface to the existing test so that the results may be analyzed. Such a mechanism may have many different architectures. One such mechanism may determine a file in which results are kept and provide a mechanism for reading or copying the file to a test results database. Another such mechanism may execute a query against a database that may contain the results.

In some embodiments, an executable service or function may be installed on a test server or on a device that may gather the test results from one or more tests.

A translation mechanism may be determined in block 214. In some cases, the test results may be in a specific format or may have excess data than what may be useful for analysis. In such a case, a translation mechanism may be used to filter or format the data into a manner that may be easily used by an analysis mechanism.

In many cases, test results may be stored and analyzed using XML. XML is a text based storage mechanism that may have a predefined schema. Such information may be readily analyzed using Xpath and other descriptors. When an existing test generates data that is not in XML format, a translation mechanism in block 214 may be configured to convert an existing data format to XML.

The test may be registered with a results collection mechanism in block 216. The results collection mechanism may be a separate function or routine that may collect various test results so that the results may be analyzed. In some embodiments, a results collection mechanism may gather results on a periodic basis, while in other embodiments, the results may be collected on demand when an analysis is to be performed.

When an analysis is to be performed in block 222, a set of tests that may be used for the analysis may be identified in block 224. The test manager may have a large number of tests, each of which may have results that may be useful. However, some analyses may analyze results from a subset of tests rather than all of the tests. For example, an analysis of a single device may include only the test results for the device. In another example, an analysis of the performance of a specific network application may include results from those devices that are affected by the network application and may exclude test results from other devices that are not affected. In some embodiments, a certain type of test may be used for an analysis while another type of test may be excluded.

Using the set of tests determined in block 224, for each device in block 226 and for each test in block 228, the data may be gathered for analysis. If current test result data is not available in block 230, the test may be launched in block 232 and the data gathered in block 234. If current test result data is available in block 230, the data may be gathered in block 234.

When the data are gathered in block 234, the data may be translated, reformatted, or otherwise processed prior to analysis. In some embodiments, the processing may include summarizing data, translating data, extracting data from a database, or other processing. In some cases, such processing may enable the data to conform to specific schemas or other formats that may be useful during analysis.

The gathered data may be stored in a test server database in block 236. In some embodiments, the gathered data may be stored in a single file or database for analysis. One such embodiment may be a single XML file that may be used for analysis. In other embodiments, the gathered data may be stored in several files.

After gathering the data in blocks 226-236, the data may be analyzed in block 238.

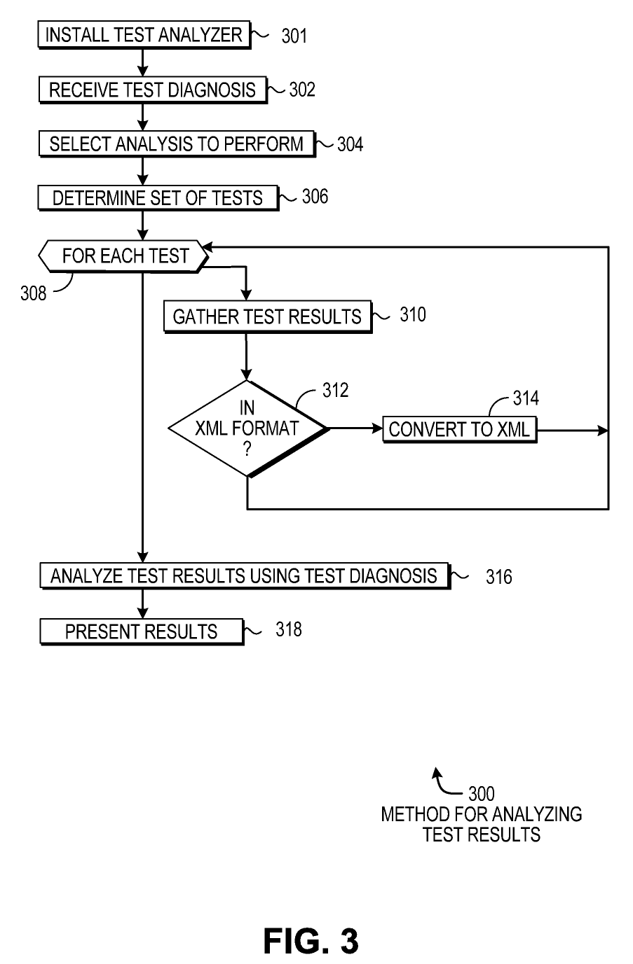

FIG. 3 is a flowchart illustration of an embodiment 300 showing a method for analyzing test results. Embodiment 300 illustrates a simplified sequence for analyzing the data that may be gathered using embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A test analyzer may be installed in block 301. The test analyzer may be part of an application or service that operates at a test server.

Test diagnostics may be received in block 302. In many embodiments, the test diagnostics may be received from a distribution server that may transmit the test diagnostics to a test server. For example, a test server may be the recipient of a subscription that includes the periodic transmission of test diagnostics to the test server. In other embodiments, when a specific analysis is selected, the test server may communicate with a distribution server to obtain the latest version of the test diagnostics.

In many embodiments, the test diagnostics may be expressed in a text based description. On example of such a description is Xpath, which may be useful for analyzing XML based test results. By using a text based description of the test diagnostics, the description may not be as great a security risk as if the description were in an executable code.

In many embodiments, the test diagnostics of block 302 may contain multiple analyses that may be performed. Each analysis may include descriptions of the data to analyze along with various parameters, algorithms, and formulas by which the test results may be analyzed to determine results.

An analysis to be performed may be selected in block 304. In many embodiments, the analysis may be initiated by a user or administrator action, such as selecting the analysis from a user interface. In some embodiments, the various test analyses may be performed on a scheduled basis or in response to some other monitored event.

The set of tests to be analyzed may be determined block 306. Such tests may correspond to the set of tests determined in block 224 of embodiment 200. In some embodiments, a test manager may gather some or all of the test results for analysis. In other embodiments, a test analyzer may perform some or all of the test results for analysis. In still other embodiments, some test results may be gathered from a results database by a test analyzer and other test results may be gathered by a test manager on demand from the test analyzer.

For each test in block 308, the test results may be gathered in block 310. If the test results are not in an XML format in block 312, the test results may be converted to XML in block 314. If the test results are already in XML in block 312, the next test is processed in block 308.

Once all the tests are processed in block 308, the test results may be analyzed in block 316 and the results may be presented in block 318.

A first example of an Xpath expression may be:

```
<rule link=“95506” relevance=“95”>
  <description>Secure connection actively refused</description>
  <condition>//test[@name=“HttpsId”]/result[@name=“body.Net” and
//contains(text( ),“refused”)]</condition>
</rule>
```

This expression may be used to find results for test named “Httpsld” where the string “refused” is found in the body of the result message. The link=“95506” expression may provide a link to an explanation of the rule, and the relevance of the test to the problem that a user may have experienced is 95%.

An example of a test output that would be returned by this rule may be:

```
<test name=“HttpsId” title=“Check EnrollId 56000 - id.xml”>
  <result name=“status”>Error</result>
  <result name=“ProxyEnabled”>False</result>
  <result name=“message”>The remote computer refused
  connection</result>
  <result name=“win32Error”>0</result>
</test>
```

A second example of an Xpath expression may be:

```
<rule link=“95499” relevance=“95”>
    <description>HTTP calls fail with “Bad Router” and Internet
Explorer has “Automatically Detect Settings” or HTTP Proxy
configured</description>
    <condition>//test[@name=“IEProxy”]/result[@name=“status”
//and text( )!=“Ok”] and test[@name=“HttpId”]/result[@name=“http.3C”
//and (number(text( ))=502 or number(text( ))=503)] and
//test[@name=“ResolveName”]/result[@name=“status” and text( )=“Ok”]
    </condition>
</rule>
```

This expression may be used to find results where test IEProxy does not have an ‘OK’ in the status field, Httpld contains 502 or 503 in the http.3c field, and ResolveName has status ‘OK’. The test explanation may be found at link 95499 and the relevance may be 95%.

An example of a test output that would be returned using this rule is:

```
<test name=“IEProxy” title=“Internet Options”>
  <result name=“status”>Warning</result>
  <result name=“AutoDetect”>True</result>
  <result name=“Proxy”>False</result>
  <result name=“ByPassLocal”>False</result>
</test>
<test name=“HttpId” title=“Check EnrollId 55000 - id.xml”>
  <result name=“status”>Ok</result>
  <result name=“ProxyEnabled”>False</result>
  <result name=“http.Net”>200</result>
  <result name=“StatusDescription”>OK</result>
  <result name=“body.Net”>&lt;ID&gt;1&lt;/ID&gt;</result>
  <result name=“hr.Send.C3”>0</result>
  <result name=“http.3C”>502</result>
  <result name=“body.C3”>&lt;ID&gt;1&lt;/ID&gt;</result>
  <result name=“hr.Send.S3”>0</result>
  <result name=“http.3S”>200</result>
  <result name=“body.S3”>&lt;ID&gt;1&lt;/ID&gt;</result>
  <result name=“hr.Send.S6”>0</result>
  <result name=“http.6S”>200</result>
  <result name=“body.S6”>&lt;ID&gt;1&lt;/ID&gt;</result>
</test>
<test name=“ResolveName” title=“Resolve Server name”>
  <result name=“status”>Ok</result> status OK
  <result name=“IP.Net”>157.59.110.244</result>
  <result name=“IPv4”>157.59.110.244</result>
  <result name=“IP”>157.59.110.244</result>
  <result name=“Subnet”>OK</result>
  <result name=“ServerFoundFromUPnP”>IMKORA-QSVR1</result>
</test>
```

The examples are presented to illustrate how an Xpath expression may be used to identify sets of test results for analysis. The Xpath expressions may be created and transmitted in text format which may have a substantially lower security risk than analysis routines that include executable code.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method comprising:
gathering a plurality of test results, said test results being in XML;
receiving a text expression of diagnostic logic, said text expression comprising an Xpath expression;
analyzing said plurality of test results using said text expression to generate an analysis; and
presenting said analysis.

2. The method of claim 1, said test results comprising results of tests performed on a plurality of devices.

3. The method of claim 1, said test results being comprised in a single file.

4. The method of claim 1, said test results being comprised in a plurality of files.

5. The method of claim 1 further comprising:
installing an analysis engine comprising executable code, said analysis engine being configured to perform said analyzing.

6. The method of claim 1 further comprising:
causing a plurality of tests to be performed to generate said plurality of test results.

7. The method of claim 1, said text expression being received in response to a subscription for said diagnostic logic.

8. The method of claim 1, said text expression being received from a server.

9. The method of claim 8, said text expression being pushed from said server.

10. The method of claim 8, said text expression being pulled from said server.

11. A system comprising:
a plurality of diagnostic tests, each of said diagnostic tests generating an XML document comprising test results;
a test manager configured to cause at least some of said plurality of tests to be performed;
a test analyzer configured to perform a method comprising:
gathering a plurality of said test results;
receiving a text expression of diagnostic logic, said text expression comprising an Xpath expression;
analyzing said plurality of test results using said text expression to generate an analysis; and
presenting said analysis.

12. The system of claim 11, said test manager further configured to schedule at least one of said plurality of tests on a recurring basis.

13. The system of claim 11, said plurality of diagnostic tests being performed on a plurality of devices, said devices being connected to a local area network.

14. The system of claim 13, at least one of said XML documents being transmitted from one of said plurality of devices to said system.

15. The system of claim 14 further comprising:
a database configured to store at least one of said XML documents.

16. The system of claim 11, said test results being comprised in a single file.

17. The system of claim 11, said test results being comprised in a plurality of files.

18. A computer readable storage medium comprising computer executable instructions configured to perform a method comprising:
installing a test manager on a server;
operating said test manager being configured to perform a method comprising:
causing at least one diagnostic test to be performed on a plurality of devices connected to said server through a local area network, said at least one diagnostic test generating test results;
installing a test analyzer on said server;
operating said test analyzer being configured to perform a method comprising:
gathering a plurality of said test results;
receiving a text expression of diagnostic logic, said text expression comprising an Xpath expression;
analyzing said plurality of test results using said text expression to generate an analysis; and
presenting said analysis.

19. The computer readable storage medium of claim 18, said test manager further configured to perform a method comprising:
storing said test results in a database.

20. The computer readable storage medium of claim 18, said test analyzer further configured to perform a method comprising:
converting at least one of said text results into XML.
